(19) United States
(12) Patent Application Publication
(10) Pub. No.: US 2024/0092413 A1
(43) Pub. Date: Mar. 21, 2024

(54) BICYCLE TRAILER

(71) Applicant: RADIO FLYER INC., Chicago, IL (US)

(72) Inventors: Michael Boyle, Chicago, IL (US); Igor Zemskov, Chicago, IL (US); Timothy Stevens, Chicago, IL (US)

(21) Appl. No.: 18/467,220

(22) Filed: Sep. 14, 2023

Related U.S. Application Data
(60) Provisional application No. 63/406,778, filed on Sep. 15, 2022.

(51) Int. Cl. B62B 7/12; B62B 7/06; B62K 27/00

(52) U.S. Cl. CPC B62B 7/126; B62B 7/06; B62K 27/003

(57) ABSTRACT

A folding bicycle trailer that converts between a bicycle trailer mode, a stroller mode, and a folded mode. The trailer has a frame having a first and second side frame assemblies, and a floor assembly. Each side frame assembly has a front wheel and a rear wheel. The front wheels are removed from the frame in the bicycle trailer mode, and are connected to the frame in the stroller and folded modes. A connection arm removably connects to a bicycle in bicycle trailer mode. The connection arm is removable in the stroller and folded modes, but can be connected to the trailer in a second position in those modes. The trailer has a removable push bar for stroller mode. The first and second side frame assemblies remain vertical but move closer to one another in the folded mode.

### CROSS-REFERENCE TO RELATED APPLICATIONS

This application claims the benefit of U.S. Provisional Patent Application No. 63/406,778 filed Sep. 15, 2022, which is expressly incorporated herein by reference and made a part hereof.

### FEDERALLY SPONSORED RESEARCH OR DEVELOPMENT

Not Applicable.

### TECHNICAL FIELD

The present subject matter relates to a bicycle trailer, and more particularly, to a folding bicycle trailer that is convertible into a stroller.

### BACKGROUND

Bicycle trailers and strollers are known in the art. While such products according to the prior art provide a number of advantages, they nevertheless have certain limitations, especially when combined together. The present disclosure seeks to overcome certain of those limitations and other drawbacks of the prior art, and to provide new features not heretofore available. A full discussion of the features and advantages of the present disclosure is deferred to the following detailed description, which proceeds with reference to the accompanying drawings.

### SUMMARY

According to certain aspects of the present disclosure, the disclosed subject technology relates to a folding tricycle trailer that converts into a stroller.

The disclosed technology further relates to a folding bicycle trailer that is convertible into a stroller, and which has a bicycle trailer mode, a stroller mode, and a folded mode, comprising: a frame having a first side frame assembly, a second side frame assembly, a floor assembly between the first side frame assembly and the second side frame assembly, and a linkage assembly between the first side frame assembly and the second side frame assembly and under the floor assembly; the floor assembly having a first floor assembly, a second floor assembly and a center brace, the first floor assembly being pivotally connected to the first side frame assembly at a first end and being pivotally connected to the center brace at a second end, the second floor assembly being pivotally connected to the second side frame assembly at a first end and being pivotally connected to the center brace at a second end; the linkage assembly pivotally connecting the first side frame assembly and the second side frame assembly; a push bar having a first end and a second end, the first end removably connected to one of the first side frame assembly and the second side frame assembly, and the second end removably connected to the other of the first side frame assembly and the second side frame assembly; a connection arm to removably connect the bicycle trailer to a bicycle, the connection arm having a first end and a second end, the second end being removably secured to the first side frame assembly in a first position in the bicycle trailer mode whereby the first end of the connection arm extends away from a front of the bicycle trailer, and the connection arm being removable from the first position and repositioned in a second position connected to the first side frame assembly whereby the connection arm does not extend beyond a front of the bicycle trailer; a first front wheel and a first rear wheel removably secured to the first side frame assembly, wherein the first front wheel is removed from the first side frame assembly in the bicycle trailer mode; a second front wheel and a second rear wheel removably secured to the second side frame assembly, wherein the second front wheel is removed from the second side frame assembly in the bicycle trailer mode; and, wherein the floor assembly and the linkage assembly pivots between the first side frame assembly and the second side frame assembly to move the first and second side frame assemblies closer to one another in the folded position.

The disclosed technology further relates to a folding bicycle trailer that is convertible into a stroller, and which has a bicycle trailer mode, a stroller mode, and a folded mode, comprising: a frame having a first side frame assembly, a second side frame assembly, and a floor assembly between the first side frame assembly and the second side frame assembly; a push bar having a first end and a second end, the first end removably connected to one of the first side frame assembly and the second side frame assembly adjacent a rear of the bicycle trailer, and the second end removably connected to the other of the first side frame assembly and the second side frame assembly adjacent the rear of the bicycle trailer; a connection arm to removably connect the bicycle trailer to a bicycle, the connection arm having a first end and a second end, the second end being removably secured to one of the first side frame assembly and the second side frame assembly in a first position in the bicycle trailer mode whereby the first end of the connection arm extends away from a front of the bicycle trailer; a first front wheel and a first rear wheel removably secured to the first side frame assembly, wherein the first front wheel is removed from the first side frame assembly in the bicycle trailer mode, and wherein the first front wheel is connected to the first side frame assembly in the stroller mode and folded mode; a second front wheel and a second rear wheel removably secured to the second side frame assembly, wherein the second front wheel is removed from the second side frame assembly in the bicycle trailer mode, and wherein the second front wheel is connected to the second side frame assembly in the stroller mode and folded mode; and, wherein the floor assembly pivots from a flat position in the bicycle trailer mode to a folded position between the first side frame assembly and the second side frame assembly in the folded mode, wherein the first and second side frame assemblies are vertical in the bicycle trailer mode, and wherein the first and second side frame assemblies remain vertical and move closer to one another in the folded mode.

The disclosed technology further relates to a folding bicycle trailer that is convertible into a stroller, and which has a bicycle trailer mode, a stroller mode, and a folded mode, comprising: a frame having a first side frame assembly, a second side frame assembly, and a floor assembly between the first side frame assembly and the second side frame assembly; a first front wheel and a first rear wheel removably secured to the first side frame assembly, wherein the first front wheel is removed from the first side frame assembly in the bicycle trailer mode, and wherein the first front wheel is connected to the first side frame assembly in the stroller mode and folded mode; a second front wheel and a second rear wheel removably secured to the second side frame assembly, wherein the second front wheel is removed from the second side frame assembly in the bicycle trailer mode, and wherein the second front wheel is connected to the second side frame assembly in the stroller mode and folded mode; a connection arm to removably connect the bicycle trailer to a bicycle, the connection arm having a first end and a second end, the second end being removably secured to one of the first side frame assembly and the second side frame assembly in a first position in the bicycle trailer mode whereby the first end of the connection arm extends away from a front of the bicycle trailer, the connection arm being removable from the frame and repositionable to a second position when the bicycle trailer is in the stroller mode and the folded mode, the second position being connected to one of the first side frame assembly and the second side frame assembly, and whereby the connection arm does not extend beyond a front of the bicycle trailer in the second position; and, wherein the floor assembly pivots from a flat position in the bicycle trailer mode to a folded position between the first side frame assembly and the second side frame assembly in the folded mode, wherein the first and second side frame assemblies are vertical in the bicycle trailer mode, and wherein the first and second side frame assemblies remain vertical and move closer to one another in the folded mode.

The disclosed technology further relates to a folding bicycle trailer further comprising a support bar having a first end and a second end, the first end being pivotally connected to one of the first side frame assembly and the second side frame assembly, the second end being removably connected to the other of the first side frame assembly and the second side frame assembly, wherein in the bicycle trailer mode and the stroller mode the support bar is in a connected position, and wherein in the folded mode the support bar is pivoted to a disconnected position.

The disclosed technology further relates to a folding bicycle trailer, wherein all of the front and rear wheels are connected to the bicycle trailer in the stroller mode and the folded mode.

The disclosed technology further relates to a folding bicycle trailer, wherein the bicycle trailer is rollable in the stroller mode and the folded mode.

The disclosed technology further relates to a folding bicycle trailer, wherein the push bar is moveable between a raised position, wherein the first end of the push bar is connected to the first side frame assembly and the second end of the push bar is connected to the second side frame assembly, and a lowered position, wherein the second end of the push bar is connected to the first side frame assembly and the first end of the push bar is connected to the second side frame assembly.

The disclosed technology further relates to a folding bicycle trailer, wherein the floor assembly has an opening adjacent a front of the bicycle trailer to provide for a foot well adjacent a front of the bicycle trailer.

The disclosed technology further relates to a folding bicycle trailer, wherein the floor assembly adjacent a rear of the bicycle trailer operates as a bottom of a seat in connection with the foot well adjacent the front of the bicycle trailer.

The disclosed technology further relates to a folding bicycle trailer, further comprising a lock connected to one of the first side frame assembly and the second side frame assembly, the lock engaging the other of the first side frame assembly and the second side frame assembly when the bicycle trailer is moved to the folded position to retain the bicycle trailer in the folded position until the lock is released by a user.

The disclosed technology further relates to a folding bicycle trailer, further comprising a linkage assembly between the first side frame assembly and the second side frame assembly and under the floor assembly, the linkage assembly pivotally connecting the first side frame assembly and the second side frame assembly in both the bicycle trailer mode and the folded mode.

The disclosed technology further relates to a folding bicycle trailer, wherein the floor assembly having a first floor assembly, a second floor assembly and a center brace, the first floor assembly being pivotally connected to the first side frame assembly at a first end and being pivotally connected to the center brace at a second end, the second floor assembly being pivotally connected to the second side frame assembly at a first end and being pivotally connected to the center brace at a second end.

The disclosed technology further relates to a folding bicycle trailer, wherein the connection arm is removable from the first position of the bicycle trailer mode and repositioned in a second position connected to one of the first side frame assembly and the second side frame assembly, whereby the connection arm does not extend beyond a front of the bicycle trailer in the second position.

The disclosed technology further relates to a folding bicycle trailer, further comprising a first wheel guard extending from the first side frame assembly between the first front wheel and the first rear wheel, and a second wheel guard extending from the second side frame assembly between the second front wheel and the second rear wheel.

The disclosed technology further relates to a folding bicycle trailer, further comprising independent brakes for the first and second rear wheels.

The disclosed technology further relates to a folding bicycle trailer, wherein the bicycle trailer has pockets to receive and hold the first and second front wheels when the bicycle trailer is in bicycle trailer mode.

The disclosed technology further relates to a folding bicycle trailer, further comprising a push bar having a first end and a second end, the first end removably connected to one of the first side frame assembly and the second side frame assembly adjacent a rear of the bicycle trailer, and the second end removably connected to the other of the first side frame assembly and the second side frame assembly adjacent the rear of the bicycle trailer.

It is understood that other embodiments and configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

To understand the present disclosure, it will now be described by way of example, with reference to the accompanying drawings in which embodiments of the disclosures are illustrated and, together with the descriptions below are incorporated in and constitute a part of this specification, and serve to explain the principles of the disclosure. In the drawings:

FIG. 1 is a front perspective view of a bicycle trailer in a first use mode, according to the present disclosure.

FIG. 2 is a front perspective view of a bicycle trailer, according to the present disclosure, shown in one of its environments of use.

FIG. 3 is rear perspective view of the bicycle trailer of FIG. 1, according to the present disclosure.

FIG. 4 is rear perspective view of the bicycle trailer of FIG. 1, according to the present disclosure, with a rear housing member in an open position.

FIG. 5 is a front perspective view of the bicycle trailer of FIG. 1 in a second use mode, according to the present disclosure.

FIG. 6 is a front perspective view of the bicycle trailer of FIG. 1 in a second mode, according to the present disclosure, with a front housing member in an open position.

FIG. 7 is a front perspective view of one embodiment of a frame assembly for the bicycle trailer, according to the present disclosure, with the connection arm removed.

FIG. 8 is a rear perspective view of one embodiment of a frame assembly for the bicycle trailer, according to the present disclosure.

FIG. 9 is a front perspective view of one embodiment of a frame assembly for the bicycle trailer, according to the present disclosure, with the connection arm connected to the frame in a second use mode.

FIG. 10 is a front perspective view of one embodiment of a frame assembly for the bicycle trailer, according to the present disclosure, with the push bar removed and a support bar disengaged to allow for folding of the bicycle trailer.

FIG. 11 is a front perspective view of one embodiment of a frame assembly for the bicycle trailer, according to the present disclosure, in a folded position.

FIG. 12 is a perspective view of one embodiment of a support bar connection for the bicycle trailer, according to the present disclosure.

FIG. 13 is a cross-sectional view of the support bar connection about line 13-13 in FIG. 12.

FIG. 14 is a perspective view of one embodiment of a front wheel connection for the bicycle trailer, according to the present disclosure.

FIG. 15 is a cross-sectional view of the front wheel connection about line 15-15 in FIG. 14.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

While this disclosure is susceptible of embodiments in many different forms, there is shown in the drawings and will herein be described in detail preferred embodiments with the understanding that the present disclosure is to be considered as an exemplification of the principles of the disclosure and is not intended to limit the broad aspect of the disclosure to the embodiments illustrated. It should be noted that the features illustrated in the drawings are not necessarily drawn to scale, and features of one embodiment may be employed with other embodiments, as one of ordinary skill in the relevant art would recognize, even if not explicitly stated herein. Further, descriptions of well-known components and processing techniques may be omitted so as to not unnecessarily obscure the embodiments of the present disclosure. The examples used herein are intended merely to facilitate an understanding of ways in which the present disclosure may be practiced and to further enable those of ordinary skill in the art to practice the embodiments of the present disclosure. Accordingly, the examples and embodiments herein should not be construed as limiting the scope of the present disclosure, which is defined solely by the appended claims and applicable law.

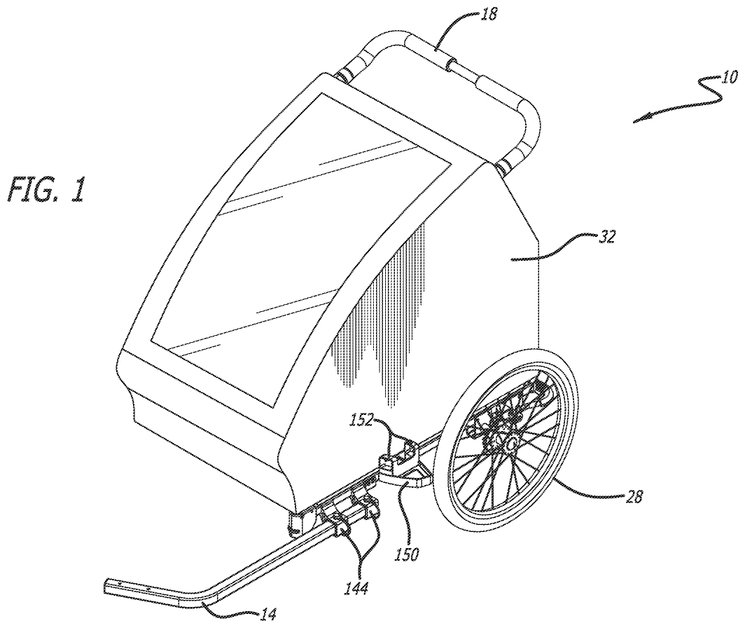

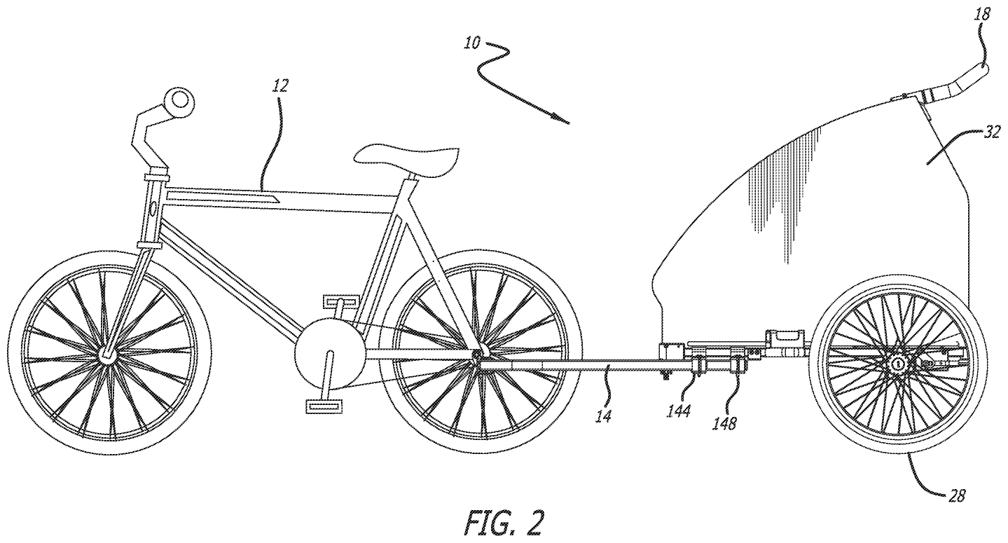

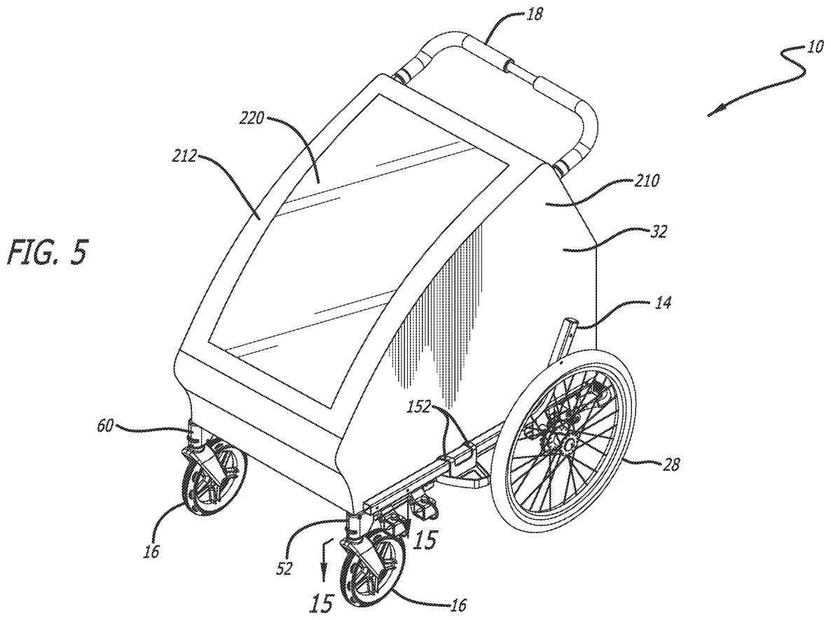

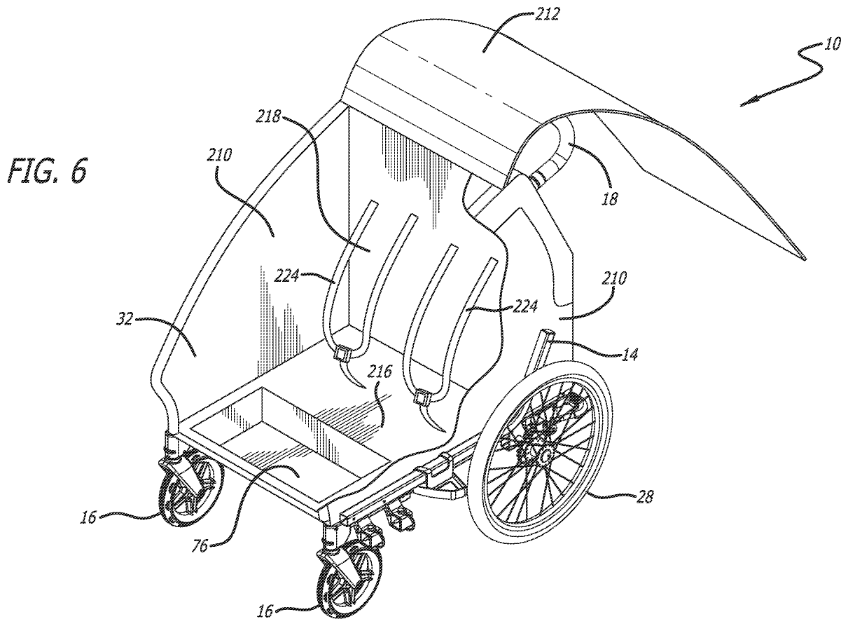

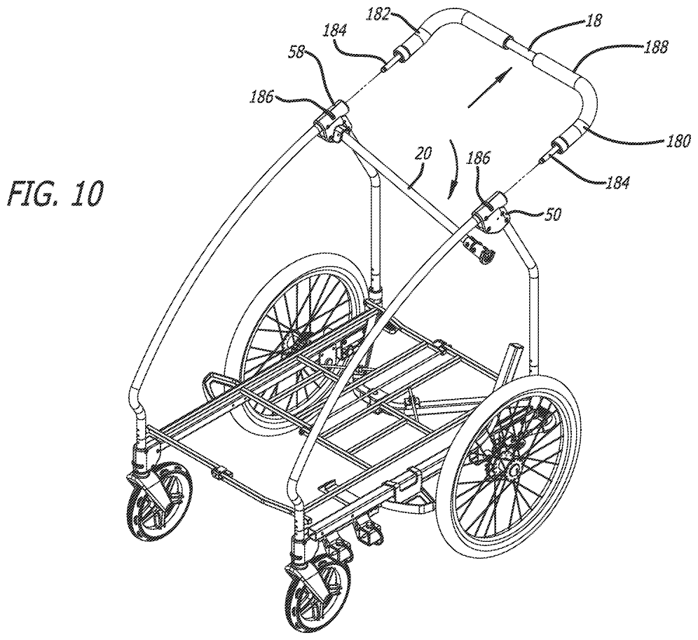

Generally, this disclosure describes several embodiments of bicycle trailers 10 that are arrangeable in a variety of different orientations, both alone and in combination, including folding bicycle trailers that are convertible into a stroller. In one embodiment, as shown in FIGS. 1-4, the bicycle trailer 10 is provided in a trailer use orientation or trailer mode. In such an embodiment, the bicycle trailer 10 is removably connected to a bicycle 12 with a connection arm 14, as shown in FIG. 2, and can be pulled by the bicycle 12. In this mode, the front wheels 16 are not connected to the frame 30 of the bicycle trailer 10. In another embodiment, as shown in FIGS. 5 and 6, the bicycle trailer 10 is provided in a stroller use orientation or stroller mode. In this orientation, the connection arm 14 is removed from the bicycle trailer 10 and stored, front wheels 16 are connected to the frame 30 of the bicycle trailer 10, and the push bar 18 is used by the user to push the bicycle trailer 10 in stroller mode. In another embodiment, as shown in FIG. 10, the bicycle trailer 10 is provided in a folded or storage orientation, also known as the folded mode. In this embodiment, the push bar 18 is removed from the bicycle trailer 10, the support bar 20 is partially disconnected and pivoted downwardly, and the floor assembly 22 of the frame 30 of the bicycle trailer 10 is folded upwardly, thereby pulling the two side frame assemblies 24, 26 of the bicycle trailer 10 toward one another to place the bicycle trailer 10 in the folded orientation. In the folded orientation, the front wheels 16 and rear wheels 28 of the bicycle trailer 10 are preferably connected to the frame 30 and the bicycle trailer 10 can be rolled on its front wheels 16 and rear wheels 28.

Referring now to the figures, and initially to FIGS. 1, 7 and 8, there is shown an embodiment of a bicycle trailer 10 having a collapsible frame 30 and a fabric housing 32. The collapsible frame 30 comprises a first side frame assembly 34, a second side frame assembly 36, a floor assembly 22 and a linkage assembly 38. In one embodiment, the floor assembly is between the first side frame assembly and the second side frame assembly. The floor assembly 22 generally comprises a first floor assembly 40 pivotally connected to the first side frame assembly 34, and a second floor assembly 42 pivotally connected to the second side frame assembly 36. The linkage assembly 38 generally connects the first side frame assembly 34 and the second side frame assembly 36. In one embodiment, the linkage assembly is between the first side frame assembly and the second side frame assembly, and under the floor assembly.

In one embodiment, the first side frame assembly 34 generally comprises a first front frame member 44, a first rear frame member 46, and a first lower frame member 48. In one embodiment, the first front frame member 44 is connected to the first rear frame member 46 via a first rear support 50. Further, in one embodiment the first front frame member 44 is orientated at an angle to the first rear frame member 46. A first end 47 of the first lower frame member 48 is connected to the first front frame member 44, and a second end 49 of the first lower frame member 48 is connected to the first rear frame member 46. In one embodiment, the first front frame member 44 is connected to the first lower frame member 48 via a first front support 52, however, supports 50 and 52 are not required in alternate embodiments and the members are connected directly to each other. Further, in one embodiment, as shown in FIG. 8, the second end 49 of the first lower frame member 48 is secured directly to the first rear frame member 46.

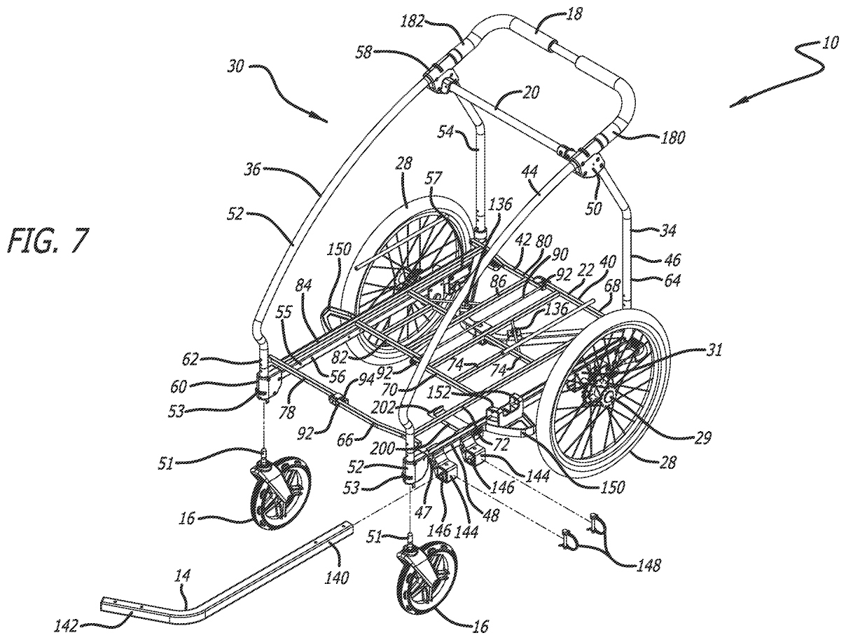

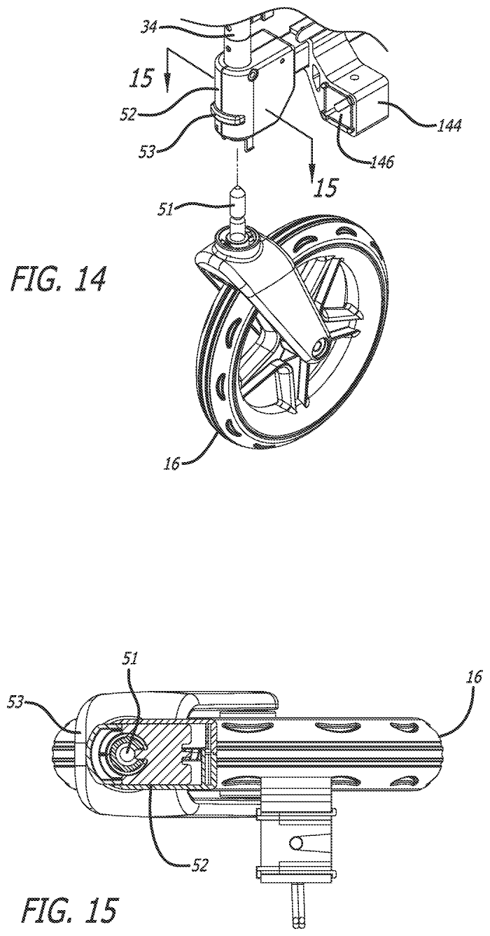

In one embodiment, one of the front wheels 16 is releasably secured to the first front support 52. As shown in FIGS. 7, 14 and 15, the front wheels 16 are preferably caster style wheels with a shaft 51 that extends into the first front support 52 and is released with a quick release button 53. In one embodiment, the front wheels 16 are in-line with the side frames. Additionally, in one embodiment, one of the rear wheels 28 is connected to the first lower frame member 48. In a preferred embodiment, the rear wheel shaft 29 is rotatably secured to a wheel housing 31 extending from the first lower frame member 48. In one embodiment, the first front wheel and the first rear wheel are removably secured to the first side frame assembly, and the first front wheel can be removed from the first side frame assembly in the bicycle trailer mode.

In one embodiment, the second side frame assembly 36 generally comprises a second front frame member 52, a second rear frame member 54, and a second lower frame member 56. In one embodiment, the second front frame member 52 is connected to the second rear frame member 54 via a second rear support 58. Further, in one embodiment the second front frame member 52 is orientated at an angle to the second rear frame member 54. A first end 55 of the second lower frame member 56 is connected to the second front frame member 52, and a second end 57 of the second lower frame member 56 is connected to the second rear frame member 54. In one embodiment, the second front frame member 52 is connected to the second lower frame member 56 via a second front support 60, however, supports 58 and 60 are not required in alternate embodiments and the members are connected directly to each other. Further, in one embodiment, the second end 57 of the second lower frame member 56 is secured directly to the second rear frame member 54.

In one embodiment, another of the front wheels 16 is releasably secured to the second front support 60. As shown in FIGS. 7, 14 and 15, the front wheel 16 has a shaft 51 that extends into the second front support 60 and is released with a quick release button 53. Additionally, in one embodiment, one of the rear wheels 28 is connected to the second lower frame member 56. In a preferred embodiment, the rear wheel shaft 29 is rotatably secured to a wheel housing 31 extending from the second lower frame member 56. In one embodiment, the second front wheel and the second rear wheel are removably secured to the second side frame assembly, and the second front wheel can be removed from the second side frame assembly in the bicycle trailer mode. In one embodiment, all of the wheels are connected to the bicycle trailer in the stroller mode and the folded mode, and thus the bicycle trailer is rollable in the stroller mode and folded mode.

As explained above, the floor assembly 22 generally comprises a first floor assembly 40 pivotally connected to the first side frame assembly 34 at a first end, and a second floor assembly 42 pivotally connected to the second side frame assembly 36 at a first end. In one embodiment, each floor assembly 40, 42 extends from adjacent the front 62 of the frame 30 to adjacent the rear 64 of the frame 30 of the bicycle trailer 10.

The first floor assembly 40 generally comprises a first end member 66, a second end member 68, a middle member 70, a first side member 72, and a plurality of central support members 74. In one embodiment, the first end member 66 is pivotally connected to the first front frame member 44 and the second end member 68 is pivotally connected to the first rear frame member 46 of the first side frame assembly 34. The first side member 72 extends between the first end member 66 and the second end member 68, and the middle member 70 extends from the first side member 72. The first end member 66, second end member 68, and the middle member 70 extend toward a center of the floor assembly 22 of the bicycle trailer 10. The plurality of central support members 74 are utilized to provide rigidity to the first floor assembly 40, and to provide a floor surface for the bicycle trailer 10. The portion of the first floor assembly 40 between the first end member 66 and the middle member 70 toward the front 62 of the frame 30 does not have central support members 74 to provide for a foot well 76 for the bicycle trailer 10 as shown in FIG. 6.

Similarly, the second floor assembly 42 generally comprises a first end member 78, a second end member 80, a middle member 82, a first side member 84, and a plurality of central support members 86. In one embodiment, the first end member 78 is pivotally connected to the second front frame member 52 and the second end member 80 is pivotally connected to the second rear frame member 54 of the second side frame assembly 36. The first side member 84 extends between the first end member 78 and the second end member 80, and the middle member 82 extends from the first side member 84. The first end member 78, second end member 80, and the middle member 82 extend toward a center of the floor assembly 22 of the bicycle trailer 10. The plurality of central support members 86 are utilized to provide rigidity to the second floor assembly 42, and to provide a floor surface for the bicycle trailer 10. The portion of the second floor assembly 42 between the first end member 78 and the middle member 82 toward the front 62 of the frame 30 does not have central support members 86 to provide for a foot well 76 for the bicycle trailer 10 as shown in FIG. 6.

The first and second floor assemblies 40, 42 are connected at a center brace 90.

Preferably, the center brace 90 is pivotally connected to the first floor assembly 40 at a second end of the first floor assembly, and the center brace 90 is pivotally connected to the second floor assembly 42 at a second end of the second floor assembly, to allow the first floor assembly 40 to be pivotally connected to the second floor assembly 42. In one embodiment, the center brace 90 is an elongated member, such as a round or other shaped tube or solid member that extends to connect each of the first and second floor assemblies 40, 42 thereto. In a preferred embodiment, the center brace 90 extends from the second end member 68, 80 of each floor assembly 40, 42 to the middle member 70, 82 of each floor assembly 40, 42 as best shown in FIGS. 7 and 8. The center brace 90 does not preferably extend to the first end member 66, 78 of each floor assembly 40, 42 to allow for the foot well 76 of the bicycle trailer 10. In one embodiment, the floor assembly thus has an opening adjacent a front of the bicycle trailer to provide for a foot well adjacent a front of the bicycle trailer.

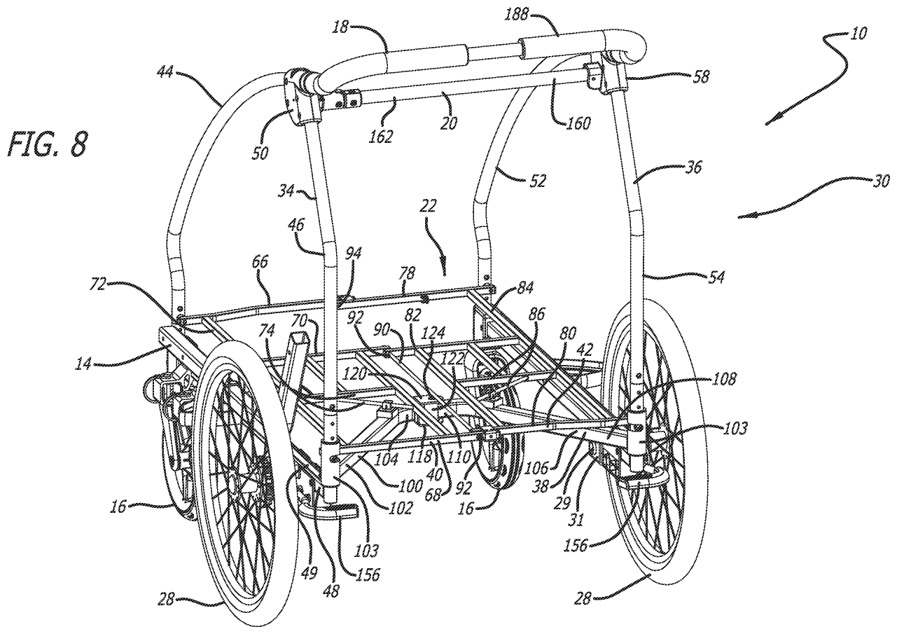

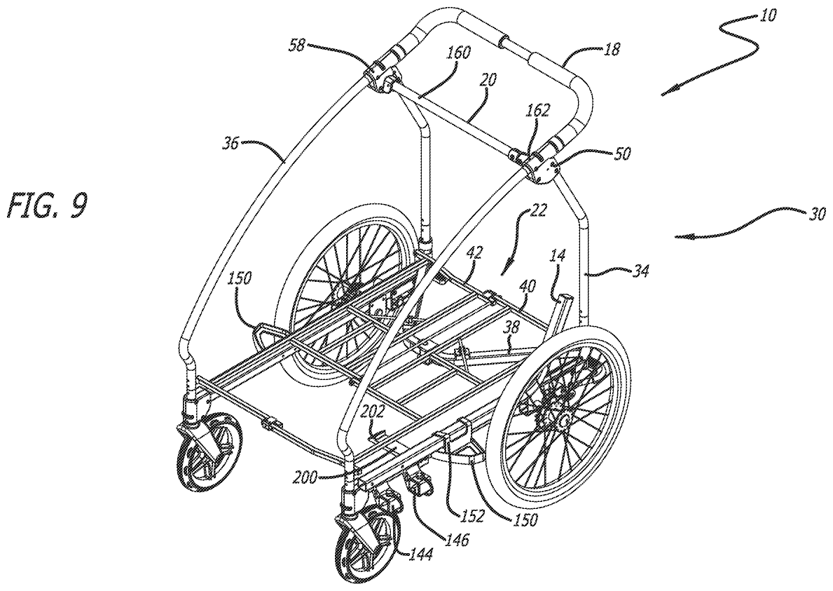

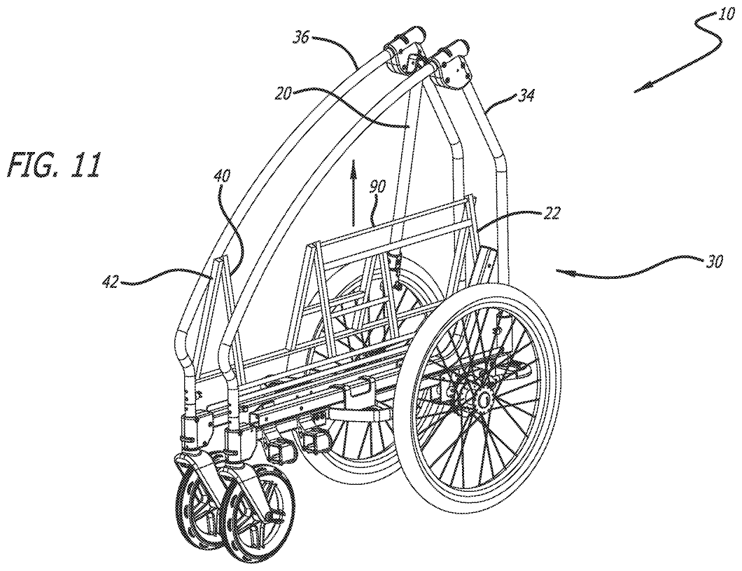

Additionally, in one embodiment, each of the first end members 66, 78, the second end members 68, 80 and the middle member 70, 82 of the floor assemblies 40, 42 has a lateral opening 92 toward its end adjacent a center of the bicycle trailer 10. The lateral openings 92 preferably have an axis that is parallel to a longitudinal axis of each of the first side frame assembly 34 and the second side frame assembly 36. The center brace 90 extends through the lateral openings 92 in each second end member 68, 80 of each floor assembly 40, 42 and each middle member 70, 82 of each floor assembly 40, 42 to pivotally connect the first and second floor assemblies 40, 42. Additionally, in one embodiment, an auxiliary center brace 94 extends through the lateral openings 92 in the first end member 66, 78 of the floor assemblies 40, 42 to further pivotally connect the first and second floor assemblies 40, 42. The first and second floor assemblies 40, 42 define the floor of the bicycle trailer 10. In one embodiment, the floor assembly adjacent a rear of the bicycle trailer operates as a bottom of a seat in connection with the foot well adjacent the front of the bicycle trailer. The first and second floor assemblies 40, 42 generally moves in a first plane to transition from the open or use configuration (FIG. 9) to the folded configuration (FIG. 11).

As best shown in FIGS. 7, 8 and 11, in one embodiment the linkage assembly 38 connects the first side frame assembly 34 to the second side frame assembly 36, and provides rigidity to the bicycle trailer in both the open and closed configurations, but also allows the bicycle trailer 10 to be collapsed or folded such that the first side frame assembly 34 and second side frame assembly 36 are adjacent one another (see FIG. 11). In one embodiment, the linkage assembly 38 is connected to the first side frame assembly 34 and the second side frame assembly 36 toward the rear 64 of the frame 30, and the linkage assembly 38 is not directly connected to the frame 30 adjacent a front 62 of the frame 30. The linkage assembly 38 preferably pivotally connects the first side frame assembly 34 to the second side frame assembly 36 in both the open configuration and the folded configuration. In one embodiment, the linkage assembly 38 comprises a first linkage 100 and a second linkage 106. Further, in one embodiment the linkage assembly 38 is positioned below the floor assemblies 40, 42 in the open configuration and in the folded configuration of the frame 30. The first linkage 100 has a first end 102 and a second end 104. The first end 102 of the first linkage 100 is pivotally connected to the first side frame assembly 34. The second linkage 106 has a first end 108 and a second end 110. The first end 108 of the second linkage 106 is pivotally connected to the second side frame assembly 36. Additionally, the first linkage 100 is pivotally connected to the second linkage 106. In one embodiment, the linkage assembly 38 is preferably v-shaped.

In one embodiment, the first end 102 of the first linkage 100 has an outer housing 103 that fits around the first side frame assembly 34 to pivotally secure the first linkage 100 to the first side frame assembly 34. In a preferred embodiment, the outer housing 103 at the first end 102 of the first linkage 100 may be a tubular member that is pivotally fitted around the first rear frame member 46 of the first side frame assembly 34, possibly with bushings and/or bearings therebetween to provide for easier rotation/pivoting of the first linkage 100 about the first side frame assembly 34. Similarly, the first end 108 of the second linkage 106 has an opening with an outer housing 103 that fits around the second side frame assembly 36 to pivotally secure the second linkage 106 to the second side frame assembly 36. In a preferred embodiment, the outer housing 103 at the first end 108 of the second linkage 106 may be a tubular member that is pivotally fitted around the second rear frame member 54 of the second side frame assembly 36, possibly with bushings and/or bearings therebetween to provide for easier rotation/pivoting of the second linkage 106 about the second side frame assembly 36. Preferably, the outer housing 103, which in a preferred embodiment, is a generally tubular or cylindrical structure, has an extended length to provide additional rigidity to the frame assembly 30 of the bicycle trailer 10.

Further, in one embodiment the second end 104 of the first linkage 100 is pivotally connected to the second end 110 of the second linkage 106. In one embodiment, the pivot connection 118 between the first linkage 100 and the second linkage 106 is that of a clevis and tang orientation. For example, one of second end 104 of the first linkage 100 or the second end 110 of the second linkage 106 has a clevis 120, and the other of the second end 104 of the first linkage 100 or the second end 110 of the second linkage 106 has a tang 122 that fits within the clevis 120. A pin 124 joins the clevis 120 and tang 122, and allows the first linkage 100 and the second linkage 106 to pivot with respect to one another during opening and closing of the bicycle trailer 10. The first linkage 100 and the second linkage 106 form a two-bar linkage to assist in keeping the first side frame assembly 34 secured to the second side frame assembly 36 in both the open configuration and the folded configuration, as well as in the transition between the open and folded configuration. The linkage assembly 38 generally moves in a second plane to transition from the open configuration shown in FIG. 9 to the folded configuration shown in FIG. 11. With reference to the plane of movement of the floor assembly, which moves in the first plane, the second plane of movement of the linkage assembly 38 is generally perpendicular to the first plane of movement of the floor assembly. Put another way, the floor assembly moves in a first plane, the linkage assembly moves in a second plane, and the first and second planes are perpendicular.

Further, as shown in FIGS. 7 and 8, in one embodiment the linkage assembly 38 may have one or more central clamp members or receivers 136 that engages one of the central support members 74, 86 of the floor assembly 20 to retain the first and second floor assemblies 40, 42 in the lower position until a sufficient force is applied to lift the floor assemblies 40, 42 and disengage the central support members 74, 86 from the respective receiver 136. Accordingly, the receiver 136 extends from the linkage assembly 38 and releasably engages the floor assembly. A tab (not shown), such as a fabric pull tab, may be connected to the receivers 136 from the central support members 74, 86 to allow a user to pull the central support members out of engagement with the receivers 136 to allow for folding of the bicycle trailer 10. In one embodiment, a force of at least 10 lbs. is required to disengage the central support members 74, 86 from the receivers 136. In that manner the floor assemblies 40, 42 should not become unintentionally disengaged from the receivers 136 and the bicycle trailer 10 will remain in the opened configuration unless intentionally manipulated to set it in motion to convert to the folded configuration. In one embodiment, the floor assembly and the linkage assembly pivot between the first side frame assembly and the second side frame assembly to move the first and second side frame assemblies closer to one another in the folded position as shown in FIG. 11.

Referring to FIGS. 1-4 and 7, the bicycle trailer 10 has a connection arm 14 to removably connect the bicycle trailer 10 to a bicycle 12. In one embodiment, the connection arm 14 has a first end 140 and a second end 142. In one embodiment, the second end of the connection arm is removably secured to the first side frame assembly in a first position in the bicycle trailer mode such that the first end of the connection arm extends away from a front of the bicycle trailer. The connection arm 14 is removable from the first position and can be repositioned in a second position connected to the first side frame assembly whereby the connection arm does not extend beyond a front of the bicycle trailer as shown in FIG. 5. Additionally, in one embodiment, the bicycle trailer 10 has at least one receiver 144 secured to the bicycle frame 30, and in one embodiment the receiver 144 is secured to the first side frame assembly 34 of the bicycle frame 30. In one embodiment, each receiver 144 has a receiver member 146, each with a retention pin 148 that extends through both the receiver member 146 and the connection arm 14 to secure the connection arm 14 to the receiver 144. In one embodiment, the first end 140 of the connection arm 14 is inserted into the two receiver members 146 and the retention pins 148 are used to secure the connection arm 14 to the receiver 144. To remove the connection arm 14, the retention pins 148 are removed and the connection arm 14 is slid back out of the receiver members 146. The second end 142 of the connection arm 14 has hardware to removably secure the connection arm 14 to the bicycle 12.

As best shown in FIGS. 1, 6 and 10, in one embodiment the bicycle trailer 10 has two wheel guards 150 to protect the rear wheels 28 from crashing into objects. One of the wheel guards 150 is connected to the first side frame assembly 34, and preferably the first lower frame member 48 of the first side frame assembly 34, and the second wheel guard 150 is connected to the second side frame assembly 36, and preferably the second lower frame member 56 of the second side frame assembly 36. In one embodiment, as shown in FIGS. 5-7 the wheel guard 150 that is connected to the first side frame assembly 34 has storage receivers 152 to removably secure the connection arm 14 to the bicycle trailer 10 for storing the connection arm 14 after it is removed from the receiver 144 for use in stroller mode or in the folded position.

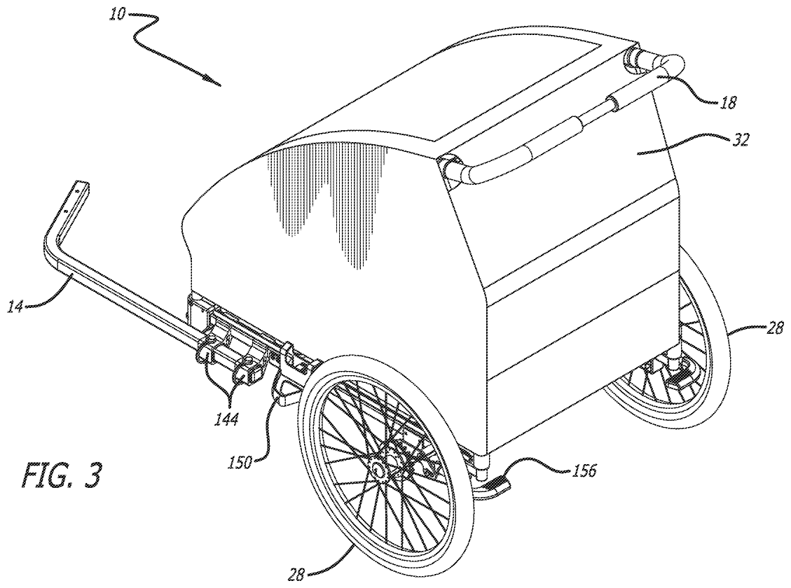

Additionally, as shown in FIGS. 3 and 8, in one embodiment the bicycle trailer 10 has independent rear brakes 156. Each rear brake 156 independently locks one of the respective rear wheel 28 of the bicycle trailer 10.

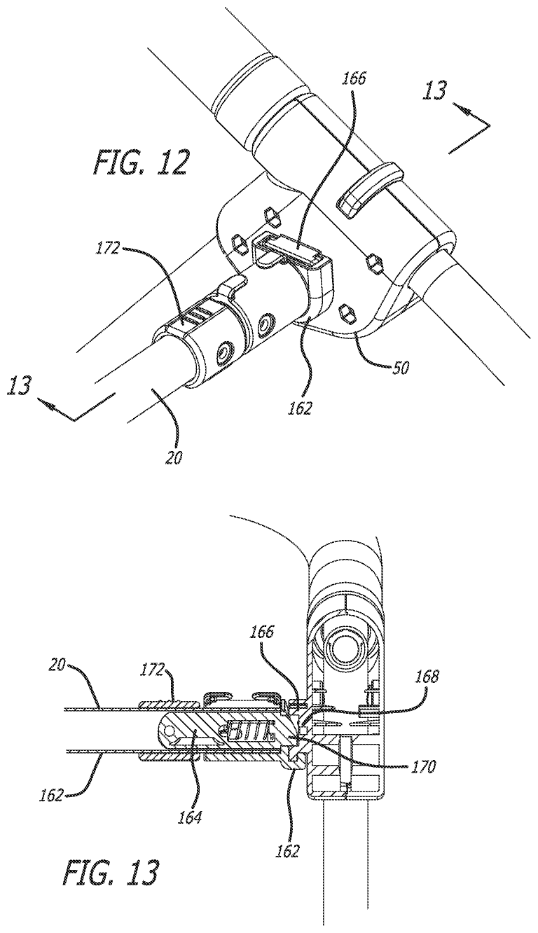

As shown in FIGS. 7 and 8, in one embodiment, the bicycle trailer 10 has a support bar 20 that is connected between the first rear support 50 and the second rear support 58. In a preferred embodiment, the support bar 20 assists in maintaining the first side frame assembly 34 and the second side frame assembly 36 in their open and distal positions. In one embodiment, the second end 160 of the support bar 20 is pivotally connected to the second rear support 58 as shown in FIGS. 10 and 11. Further, in one embodiment, the first end 162 of the support bar 20 is removably connected to the first rear support 50 via a spring loaded pin connection 164, as shown in FIGS. 12 and 13. As shown in FIGS. 12 and 13, the first rear support 50 has a seat 166 for receiving the first end 162 of the support bar 20. The first rear support 50 also has an opening 168 adjacent the seat 166 for receiving a pin 170 of the spring loaded pin connection 164 that is biased toward the extended position to fit within the opening 168 and lock the support bar 20 in the support position as shown in FIGS. 9, 12 and 13. The pin 170 can be extracted from the opening 168 when the user moves the actuator 172, which is connected to the spring loaded pin connection 164, away from the first rear support 50, and then the first end 162 of the support bar 20 can be removed from the seat 166 of the first rear support 50. After the first end 162 of the support bar 20 is removed from the seat 166 of the first rear support 50, the support bar 20 can be pivoted downward via the pivot connection of the second end 16 of the support bar 20 with the second rear support 58 as shown in FIG. 10. In one embodiment, the first end of the support bar is pivotally connected to one of the first side frame assembly and the second side frame assembly, and the second end of the support bar is removably connected to the other of the first side frame assembly and the second side frame assembly. Further, in the bicycle trailer mode and the stroller mode the support bar is in a connected position, and in the folded mode the support bar is pivoted to a disconnected position.

In one embodiment, the bicycle trailer 10 also has a removable push bar 18. The push bar 18 has a first end 180 removably connected to the first rear support 50, and a second end 182 removably connected to the second rear support 58. Alternately, the first end 180 of the push bar 18 can be removably connected to the second rear support 58 and the second end 182 can be removably connected to the first rear support 50. In one embodiment, the push bar has a first end and a second end, the first end removably connected to one of the first side frame assembly and the second side frame assembly, and the second end removably connected to the other of the first side frame assembly and the second side frame assembly. Similar to the front caster wheels 26, in one embodiment, the first end 180 and second end 182 of the push bar 18 each have a shaft 184 that extends into an opening in the respective rear support 50, 58 and that is locked therein. Each rear support 50, 58, however, has a quick release button 186 to allow for unlocking and removal of the shaft 184 to disengage the push bar 18 from the frame 30 as shown in FIG. 10. Additionally, in one embodiment, the push bar 18 has a handle 188 that is angled away from the axis of the shafts 184 of the push bar 18. Accordingly, in such an embodiment, the push bar 18 can be inserted one way to have the handle 188 in a raised position, and the opposite way to have the handle 188 in the lowered position to account for different height users.

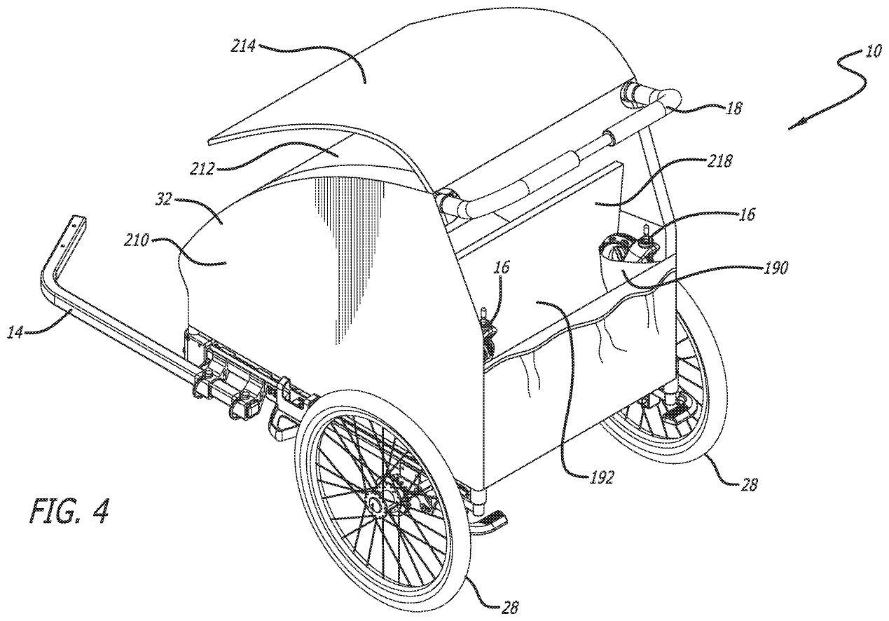

As explained herein, the bicycle trailer 10 can be removably connected to a bicycle 12 with the connection arm 14, as shown in FIG. 2, and can be pulled by the bicycle 12. In this mode, the front wheels 16 are not connected to the frame 30 of the bicycle trailer 10. In another mode, as shown in FIGS. 5 and 6, the bicycle trailer 10 is converted to a stroller use orientation. To convert the bicycle trailer 10 from the trailer orientation of FIG. 2 to the stroller orientation of FIGS. 5 and 6, the connection arm 14 is removed from the receiver 144 and inserted into the storage receiver 152. Additionally, the front wheels 26, which are preferably stored in pouches 190 in the rear compartment 192, as shown in FIG. 4, are connected to the first and second front supports 52, 56 as explained herein and shown in FIGS. 5 and 14-15.

Referring to FIGS. 7-11, the bicycle trailer 10 can be folded for storage, transport, etc. To convert the bicycle trailer 10 to the folded/storage configuration, the push bar 18 is removed from the frame 30 as explained herein, and shown in FIG. 10, and typically stored in the rear compartment 192. Next, the first end 162 of the support bar 20 is removed from the seat 166 of the first rear support 50 and the support bar 20 is pivoted downward via the pivot connection of the second end 16 of the support bar 20 with the second rear support 58, also as shown in FIG. 10. Next, the floor assembly 22 is pivoted upward at the center brace 90 by pulling up on the floor strap (not shown), which in turn allows the first and second side frame assemblies 34, 36 to be moved toward one another as shown in FIG. 11. As explained herein, in the folded orientation the front wheels 16 and rear wheels 28 of the bicycle trailer 10 are preferably connected to the frame 30 and the bicycle trailer 10 can be rolled on its front and rear wheels 26, 28.

The bicycle trailer 10 also has a lock 200 connected to one of the side frame assemblies. In one embodiment, as shown in FIG. 7, the lock 200 is connected to the first lower frame member 48 of the first side frame assembly 34. The lock 200 has a shoulder 202 at the distal end thereof that engages the second lower frame member 56 when the frame 30 is folded as shown in FIG. 11. The lock 200 retains the frame 30 in the folded orientation until unlocked by pushing downward on the shoulder 202 to disengage the lock 200 from the second lower frame member 56. In one embodiment, the lock is connected to one of the first side frame assembly or the second side frame assembly, and the lock engages the other of the first side frame assembly or the second side frame assembly when the bicycle trailer is moved to the folded position to retain the bicycle trailer in the folded position until the lock is released by a user.

The bicycle trailer 10 also has a fabric housing 32. As shown in FIGS. 1-6, in various embodiments, the fabric housing 32 may comprise outer walls 210, a front cover 212, a rear cover 214, a floor 216, a seat 218 and a rear compartment 192. In one embodiment, the front cover 212 generally extends from adjacent the support bar 20 of the frame 30 to adjacent the front 62 of the frame 30, and from the first side frame assembly 34 to the second side frame assembly 36. The front cover 212 may have a screen area 220 or a window area 220.

Additionally, the front cover 212 may be removed or rolled back. Similarly, the rear cover 214 generally extends from adjacent the support bar 20 of the frame 30 to adjacent the rear 64 of the frame 30, and from the first side frame assembly 34 to the second side frame assembly 36. The rear cover 214 may similarly be removed or rolled back. The floor 216 of the fabric housing 32 preferably includes a foot well 76 as shown in FIG. 6. The seats 218 preferably comprises two side-by-side seats 218 with seat belts 224. Behind the seats 218 is a rear compartment 192 with pouches 190 for holding items such as the front wheels 16, etc.

The embodiment's detailed hereinabove may be combined in full or in part, with any alternative embodiments described.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

Numerous modifications to the present disclosure will be apparent to those skilled in the art in view of the foregoing description. Preferred embodiments of this disclosure are described herein, including the best mode known to the inventors for carrying out the disclosure. It should be understood that the illustrated embodiments are exemplary only, and should not be taken as limiting the scope of the disclosure.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” “third,” and “fourth” as used herein are intended for illustrative purposes only and do not limit the embodiments in any way. Further, the term “plurality” as used herein indicates any number greater than one, either disjunctively or conjunctively, as necessary, up to an infinite number. Additionally, the term “having” as used herein in both the disclosure and claims, is utilized in an open-ended manner.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

It will be understood that the present disclosure may be embodied in other specific forms without departing from the spirit or central characteristics thereof. The present examples and embodiments, therefore, are to be considered in all respects as illustrative and not restrictive, and the Claims are not to be limited to the details given herein. Accordingly, while the specific embodiments have been illustrated and described, numerous modifications come to mind without significantly departing from the spirit of the disclosure and the scope of protection is only limited by the scope of the accompanying Claims.

Further, the claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A folding bicycle trailer that is convertible into a stroller, and which has a bicycle trailer mode, a stroller mode, and a folded mode, comprising:
a frame having a first side frame assembly, a second side frame assembly, a floor assembly between the first side frame assembly and the second side frame assembly, and a linkage assembly between the first side frame assembly and the second side frame assembly and under the floor assembly;
the floor assembly having a first floor assembly, a second floor assembly and a center brace, the first floor assembly being pivotally connected to the first side frame assembly at a first end and being pivotally connected to the center brace at a second end, the second floor assembly being pivotally connected to the second side frame assembly at a first end and being pivotally connected to the center brace at a second end;
the linkage assembly pivotally connecting the first side frame assembly and the second side frame assembly;
a push bar having a first end and a second end, the first end removably connected to one of the first side frame assembly and the second side frame assembly, and the second end removably connected to the other of the first side frame assembly and the second side frame assembly;
a connection arm to removably connect the bicycle trailer to a bicycle, the connection arm having a first end and a second end, the second end being removably secured to the first side frame assembly in a first position in the bicycle trailer mode whereby the first end of the connection arm extends away from a front of the bicycle trailer, and the connection arm being removable from the first position and repositioned in a second position connected to the first side frame assembly whereby the connection arm does not extend beyond a front of the bicycle trailer;
a first front wheel and a first rear wheel removably secured to the first side frame assembly, wherein the first front wheel is removed from the first side frame assembly in the bicycle trailer mode;
a second front wheel and a second rear wheel removably secured to the second side frame assembly, wherein the second front wheel is removed from the second side frame assembly in the bicycle trailer mode; and,
wherein the floor assembly and the linkage assembly pivots between the first side frame assembly and the second side frame assembly to move the first and second side frame assemblies closer to one another in the folded position.

2. The folding bicycle trailer of claim 1, further comprising a support bar having a first end and a second end, the first end being pivotally connected to one of the first side frame assembly and the second side frame assembly, the second end being removably connected to the other of the first side frame assembly and the second side frame assembly, wherein in the bicycle trailer mode and the stroller mode the support bar is in a connected position, and wherein in the folded mode the support bar is pivoted to a disconnected position.

3. The folding bicycle trailer of claim 1, wherein all of the front and rear wheels are connected to the bicycle trailer in the stroller mode and the folded mode.

4. The folding bicycle trailer of claim 3, wherein the bicycle trailer is rollable in the stroller mode and the folded mode.

5. The folding bicycle trailer of claim 1, wherein the push bar is moveable between a raised position, wherein the first end of the push bar is connected to the first side frame assembly and the second end of the push bar is connected to the second side frame assembly, and a lowered position, wherein the second end of the push bar is connected to the first side frame assembly and the first end of the push bar is connected to the second side frame assembly.

6. The folding bicycle trailer of claim 1, wherein the floor assembly has an opening adjacent a front of the bicycle trailer to provide for a foot well adjacent a front of the bicycle trailer.

7. The folding bicycle trailer of claim 6, wherein the floor assembly adjacent a rear of the bicycle trailer operates as a bottom of a seat in connection with the foot well adjacent the front of the bicycle trailer.

8. The folding bicycle trailer of claim 1, further comprising a lock connected to one of the first side frame assembly and the second side frame assembly, the lock engaging the other of the first side frame assembly and the second side frame assembly when the bicycle trailer is moved to the folded position to retain the bicycle trailer in the folded position until the lock is released by a user.

9. A folding bicycle trailer that is convertible into a stroller, and which has a bicycle trailer mode, a stroller mode, and a folded mode, comprising:
a frame having a first side frame assembly, a second side frame assembly, and a floor assembly between the first side frame assembly and the second side frame assembly;
a push bar having a first end and a second end, the first end removably connected to one of the first side frame assembly and the second side frame assembly adjacent a rear of the bicycle trailer, and the second end removably connected to the other of the first side frame assembly and the second side frame assembly adjacent the rear of the bicycle trailer;
a connection arm to removably connect the bicycle trailer to a bicycle, the connection arm having a first end and a second end, the second end being removably secured to one of the first side frame assembly and the second side frame assembly in a first position in the bicycle trailer mode whereby the first end of the connection arm extends away from a front of the bicycle trailer;
a first front wheel and a first rear wheel removably secured to the first side frame assembly, wherein the first front wheel is removed from the first side frame assembly in the bicycle trailer mode, and wherein the first front wheel is connected to the first side frame assembly in the stroller mode and folded mode;
a second front wheel and a second rear wheel removably secured to the second side frame assembly, wherein the second front wheel is removed from the second side frame assembly in the bicycle trailer mode, and wherein the second front wheel is connected to the second side frame assembly in the stroller mode and folded mode; and,
wherein the floor assembly pivots from a flat position in the bicycle trailer mode to a folded position between the first side frame assembly and the second side frame assembly in the folded mode, wherein the first and second side frame assemblies are vertical in the bicycle trailer mode, and wherein the first and second side frame assemblies remain vertical and move closer to one another in the folded mode.

10. The folding bicycle trailer of claim 9, further comprising a linkage assembly between the first side frame assembly and the second side frame assembly and under the floor assembly, the linkage assembly pivotally connecting the first side frame assembly and the second side frame assembly in both the bicycle trailer mode and the folded mode.

11. The folding bicycle trailer of claim 9, the floor assembly having a first floor assembly, a second floor assembly and a center brace, the first floor assembly being pivotally connected to the first side frame assembly at a first end and being pivotally connected to the center brace at a second end, the second floor assembly being pivotally connected to the second side frame assembly at a first end and being pivotally connected to the center brace at a second end.

12. The folding bicycle trailer of claim 9, wherein the connection arm is removable from the first position of the bicycle trailer mode and repositioned in a second position connected to one of the first side frame assembly and the second side frame assembly, whereby the connection arm does not extend beyond a front of the bicycle trailer in the second position.

13. The folding bicycle trailer of claim 9, wherein the floor assembly has an opening adjacent the front of the bicycle trailer to provide for a foot well adjacent a front of the bicycle trailer.

14. The folding bicycle trailer of claim 13, wherein the floor assembly adjacent a rear of the bicycle trailer operates as a bottom of a seat in connection with the foot well adjacent the front of the bicycle trailer.

15. The folding bicycle trailer of claim 9, further comprising a first wheel guard extending from the first side frame assembly between the first front wheel and the first rear wheel, and a second wheel guard extending from the second side frame assembly between the second front wheel and the second rear wheel.

16. The folding bicycle trailer of claim 9, further comprising independent brakes for the first and second rear wheels.

17. The folding bicycle trailer of claim 9, wherein the bicycle trailer has pockets to receive and hold the first and second front wheels when the bicycle trailer is in bicycle trailer mode.

18. A folding bicycle trailer that is convertible into a stroller, and which has a bicycle trailer mode, a stroller mode, and a folded mode, comprising:
a frame having a first side frame assembly, a second side frame assembly, and a floor assembly between the first side frame assembly and the second side frame assembly;
a first front wheel and a first rear wheel removably secured to the first side frame assembly, wherein the first front wheel is removed from the first side frame assembly in the bicycle trailer mode, and wherein the first front wheel is connected to the first side frame assembly in the stroller mode and folded mode;
a second front wheel and a second rear wheel removably secured to the second side frame assembly, wherein the second front wheel is removed from the second side frame assembly in the bicycle trailer mode, and wherein the second front wheel is connected to the second side frame assembly in the stroller mode and folded mode;
a connection arm to removably connect the bicycle trailer to a bicycle, the connection arm having a first end and a second end, the second end being removably secured to one of the first side frame assembly and the second side frame assembly in a first position in the bicycle trailer mode whereby the first end of the connection arm extends away from a front of the bicycle trailer, the connection arm being removable from the frame and repositionable to a second position when the bicycle trailer is in the stroller mode and the folded mode, the second position being connected to one of the first side frame assembly and the second side frame assembly, and whereby the connection arm does not extend beyond the front of the bicycle trailer in the second position; and,
wherein the floor assembly pivots from a flat position in the bicycle trailer mode to a folded position between the first side frame assembly and the second side frame assembly in the folded mode, wherein the first and second side frame assemblies are vertical in the bicycle trailer mode, and wherein the first and second side frame assemblies remain vertical and move closer to one another in the folded mode.

19. The folding bicycle trailer of claim 18, further comprising a push bar having a first end and a second end, the first end removably connected to one of the first side frame assembly and the second side frame assembly adjacent a rear of the bicycle trailer, and the second end removably connected to the other of the first side frame assembly and the second side frame assembly adjacent the rear of the bicycle trailer.

20. The folding bicycle trailer of claim 18, wherein the floor assembly has an opening adjacent a front of the bicycle trailer to provide for a foot well adjacent a front of the bicycle trailer, and wherein the floor assembly adjacent a rear of the bicycle trailer operates as a bottom of a seat in connection with the foot well adjacent the front of the bicycle trailer.
